(19) United States
(12) Patent Application Publication
(10) Pub. No.: US 2008/0174639 A1
(43) Pub. Date: Jul. 24, 2008

(54) INK-JET PRINT HEAD AND METHOD FOR MANUFACTURING THE SAME

(75) Inventors: Sung Joon PARK, Suwon-si (KR); Jeong Wuk HAN, Suwon-si (KR); Yong Shik PARK, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/946,250

(22) Filed: Nov. 28, 2007

(30) Foreign Application Priority Data
Jan. 18, 2007 (KR) 2007-5707

(51) Int. Cl. B41J 2/05; B23P 17/00; B21D 53/76

(52) U.S. Cl. 347/65; 29/890.1; 347/58

(57) ABSTRACT

An ink-jet print head and a method for manufacturing the same. The ink-jet print head includes: an ink ejection part to eject ink; pad regions having connecting pads to apply an electric signal to the ink ejection part; and unitary partition walls disposed at outer edges of the pad regions. The partition walls prevent particles, which are generated when cutting apart adjacent print heats when manufacturing the ink-jet print head, from scattering onto the pad regions. The partition walls are formed together with a flow channel layer and a nozzle layer of the ink ejection part.

### CROSS-REFERENCE TO RELATED APPLICATION

This application claims the benefit of Korean Application No. 2007-5707, filed Jan. 18, 2007, in the Korean Intellectual Property Office, the disclosure of which is incorporated herein by reference.

### BACKGROUND OF THE INVENTION

1. Field of the Invention

Aspects of the present invention relate to an ink-jet print head and a method for manufacturing the same, and more particularly to an ink-jet print head manufactured according to a method of preventing contamination of essential components when cutting a wafer, to separate head chips from each other.

2. Description of the Related Art

An ink-jet print head is a device which forms an image by ejecting ink droplets on a printing medium. Ink-jet print heads are largely classified into an electro-thermal type or a piezoelectric type, according to the ink droplet ejection mechanism. The electro-thermal type print head generates bubbles in the ink using a heat source, and ejects the ink droplets by the expansive force of the bubbles.

In general, the electro-thermal type print head includes: a substrate having a plurality of heaters to heat the ink and a plurality of connecting pads to connect the heaters to an exterior circuit; a flow channel layer having flow channels and ink chambers, on the substrate; and a nozzle layer, which is disposed on the flow channel layer, with nozzles corresponding to the ink chambers.

The ink-jet print head is manufactured on a wafer. In other words, an array of ink-jet print heads is formed on one wafer and the wafer is cut by a wheel saw, to separate the individual ink-jet print heads. In the process of cutting the wafer, if wafer particles scatter and contaminate the surfaces of the connecting pads, the interior of the nozzles, or the interior of the ink chambers, an electric signal is erroneously transmitted to the heaters, or the ink cannot smoothly flow through the ink chambers and the nozzles, thereby deteriorating the print quality thereof. Therefore, it is important to protect the components of the head from the particles scattered when cutting the wafer.

The connecting pads of the ink-jet print head are connected to cables of a flexible printed circuit (FPC) having a plurality of lead wires, corresponding to the connecting pads. When bonding the lead wires of the FPC cables to the connecting pads of the print head, if the lead wires contact the surface of the substrate, an electrical short may happen. Therefore, it is also important to prevent the lead wires from contacting the surface of the substrate, when bonding the lead wires to the connecting pads.

Korean Patent Laid-open Publication No. 2005-0072356 discloses a semiconductor wafer and a method for manufacturing the same, which is capable of preventing an electrical short between lead wires of FPC cables and a semiconductor substrate, by forming a buffer layer pattern on a scribe lane. However, the disclosed conventional semiconductor wafer is structured to prevent the electrical short, by forming the buffer layer pattern only on the regions of the scribe lane corresponding to the positions of the connecting pads, but suggests no solution to contamination of the head, due to the scattered particles. Thus, there is problem that components of the head are contaminated when separating the print heads on a wafer, thereby causing print head malfunction.

### SUMMARY OF THE INVENTION

Aspects of the present invention provide an ink-jet print head manufacturing method, which is capable of preventing an electrical short between lead wires of FPC cables and a substrate, and the contamination of components of the head, due to scattered particles produced when cutting a wafer.

It is another aspect of the invention to provide an ink-jet print heat manufactured according to the above method.

An exemplary embodiment of the present invention provides an ink-jet print head including an ink ejection part to eject ink, and pad regions having connecting pads to apply an electric signal to the ink ejection part. Partition walls are formed at outer edges of the pad regions, in a unitary body. The partition walls prevent particles, which are generated when cutting a wafer including the ink-jet print head, from scattering on the pad regions.

According to aspects of the invention, the partition walls include an extending portion, which extends along one side of the pad region, and bent portions, which extend along opposing sides of the pad region, at an angle from the extending portion. The partition walls surround at least three sides of the pad regions.

According to aspects of the invention, the ink ejection part includes a flow channel layer defining an ink chamber, which is filled with the ink. The bent portions extend toward the flow channel layer and are connected to the flow channel layer.

According to aspects of the invention, the ink ejection part includes a nozzle layer having a nozzle through which the ink is ejected. The bent portions extend toward the nozzle layer and are connected to the nozzle layer.

According to aspects of the invention, the partition wall may include a first layer, which is made of the same material as the flow channel layer, and a second layer which is disposed on the first layer, and made of the same material as the nozzle layer.

According to aspects of the invention, the partition wall has the same height as the nozzle layer.

An exemplary embodiment of the present invention provides an ink-jet print head comprising: an ink ejection part, which has a flow channel layer and a nozzle layer disposed on the flow channel layer; pad regions, which are provided at outer edges of the flow channel layer and the nozzle layer, and have a plurality of connecting pads to control the ink ejection part; and partition walls, which surround the pad regions together with the flow channel layer and the nozzle layer.

An exemplary embodiment of the present invention provides a method for manufacturing an ink-jet print head, including an ink ejection part to eject ink and pad regions having connecting pads to control the ink ejection part, the method comprising: forming the ink ejection part and the connecting pads on each of a plurality of head chip regions, which are provided on a wafer, the head chip regions being partitioned by cutting regions; forming partition walls between the pad regions and the cutting regions, while forming the ink ejection part to divide the pad regions from the cutting regions; attaching a protective member to cover the ink ejection part, the pad regions, and the partition walls; and cutting the wafer along the cutting regions, to separate the head chip regions from each other.

According to aspects of the invention, the forming of the partition wall b) includes: forming an extending portion, which extends along one side of the pad region, and forming bent portions, which are bent from the extending portion, to divide another side of the pad region from the cutting region. The partition wall surrounds at least three sides of the pad region.

According to aspects of the invention, the forming of the ink ejection part includes: forming a flow channel layer defining an ink chamber. The partition wall includes a first layer which is formed together with the flow channel layer.

According to aspects of the invention, the forming of the ink ejection part further includes: forming a nozzle layer on the flow channel layer. The partition wall further includes a second layer which is formed together with the nozzle layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the exemplary embodiments of the invention will become apparent and more readily appreciated from the following description of the embodiments, taken in conjunction with the accompanying drawings, of which:

FIG. 1 is a sectional view illustrating an ink-jet print head, in accordance with aspects of the present invention;

FIG. 2 is a plan view illustrating a plurality of ink-jet print heads arranged on a wafer, in accordance with aspects of the present invention;

FIGS. 3A-3K illustrate a method of manufacturing an ink-jet print head, in accordance with aspects of the present invention; and

FIG. 4 is a sectional view illustrating lead wires of an FPC connected to an ink-jet print head, in accordance with aspects of the present invention.

### DETAILED DESCRIPTION OF THE EXEMPLARY EMBODIMENTS

Reference will now be made in detail to exemplary embodiments of the present invention, examples of which are illustrated in the accompanying drawings, wherein like reference numerals refer to like elements throughout. The embodiments are described below, in order to explain the aspects of present invention, by referring to the figures.

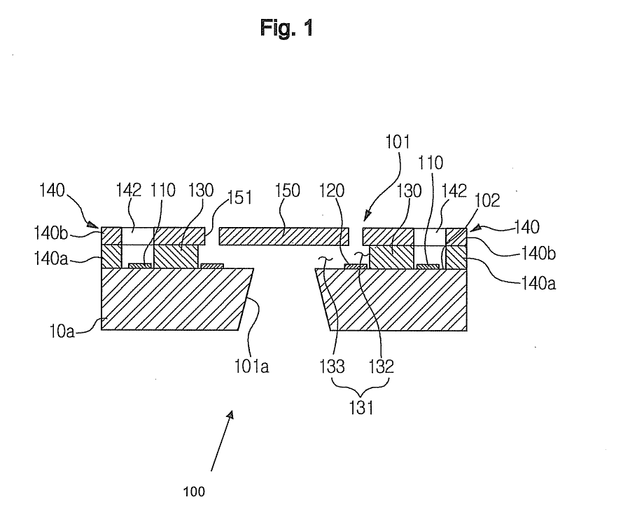

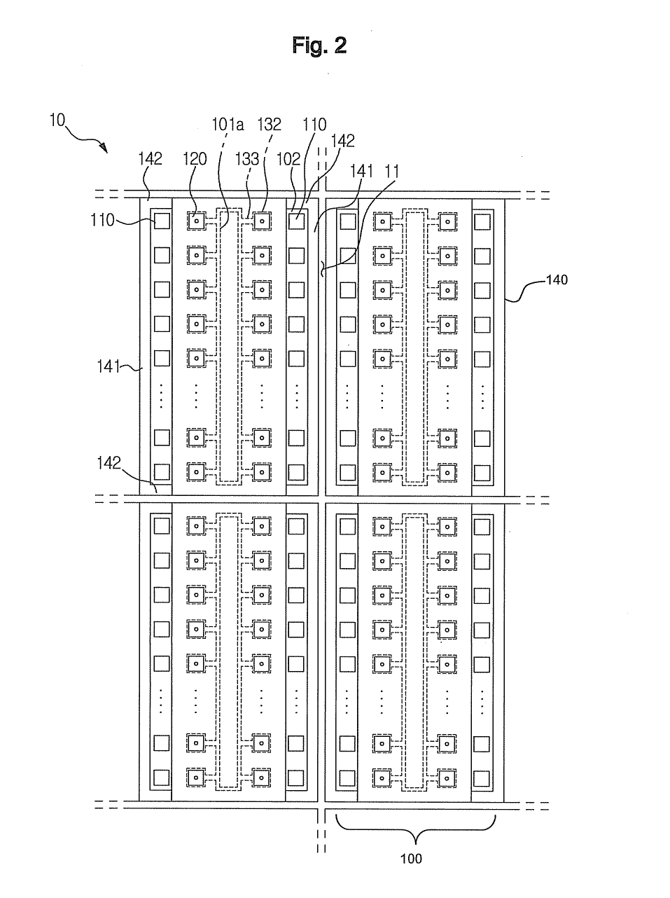

FIG. 1 is a sectional view illustrating an ink-jet print head 100, in accordance with aspects of the present invention, and FIG. 2 is a plan view illustrating a plurality of ink-jet print heads 100, which are arranged in an array on a wafer 10.

As shown in FIG. 1, the ink-jet print head 100 includes: a substrate 10a; an ink ejection part 101, which is formed on the substrate 10a, to eject ink; connecting pads 110 which are connected to an exterior circuit and transmits an electric signal to control the ink ejection part 101; and pad regions 102 on which the connecting pads 110 are disposed. The pad regions 102 are positioned on the substrate 10a, on both sides of the ink ejection part 101.

The ink ejection part 101 includes an ink supply port 101a formed in the substrate 10a, which is to supply the ink to the ink ejection part 101. The ink ejection part 101 includes a flow channel layer 130, which is disposed on the substrate 10a; and a nozzle layer 150, which is disposed on the flow channel layer 130. The flow channel layer 130 defines an ink flow channel 131, which connects the ink supply port 101a and the nozzle 151. The ink flow channel 131 includes an ink chamber 132, which is filled with the ink, and a restrictor 133, which connects the ink supply port 101a and the ink chamber 132. The nozzle 151 is formed in the nozzle layer 150, to eject the ink from the ink chamber 132.

A heater 120 is mounted in the ink chamber 132 on the substrate 10a. A plurality of the heaters 120 are used to heat the ink in the ink chambers 132.

The ink is supplied to the ink flow channel 131, from below the substrate 10a, through the ink supply port 101a. The ink supplied through the ink supply port 101a flows into the ink chamber 132, and is heated by the heater 120. The heater 120 receives the electric signal from the connecting pad 110 connected to the exterior circuit, and generates heat. The ink heated by the heater 120 generates explosive bubbles, and a portion of the ink in the ink chamber 132 is ejected by the bubbles through the nozzle 151, provided above the ink chamber 132.

The ink-jet print head 100 is manufactured on a wafer 10, as shown in FIG. 2. In other words, a plurality of the ink-jet print heads 100, as depicted in FIG. 1, are manufactured as an array of ink-jet print heads 100 on the wafer 100. The wafer 10 is cut to separate each of the ink-jet print heads 100.

As shown in FIGS. 1 and 2, cutting regions 11 are provided between adjacent ink-jet print heads 100. Each of the ink-jet print heads 100 is formed with partition walls 140 at outer edges of the pad regions 102, i.e., between the pad regions 102 and the cutting regions 11. The partition walls 140 prevent processing byproducts (hereinafter, called “particles”), which are generated when cutting apart the ink-jet print heads 100, from scattering onto the pad region 102. In order to effectively prevent the scattering of the particles on the pad region 102, the partition walls 140 are formed as a unitary body.

The partition wall 140 includes an extending portion 141, which extends vertically along one side of the pad region 102, to divide the pad region 102 from vertical portions of the cutting region 11, and two bent portions 142, which extend horizontally from the both ends of the extending portion 141, to divide the pad region 102 from horizontal portions of the cutting regions 11. The bent portions 142 extend to the flow channel layer 130 and the nozzle layer 150. Accordingly, three sides of the pad region 102 are surrounded by the partition wall 140.

The partition wall 140 may be formed together with the flow channel layer 130 and the nozzle layer 150. In other words, the partition wall 140 may include a first layer 140a which is made of the same material as the flow channel layer 130, and a second layer 140b which is disposed on the first layer 140a, and made of the same material as the nozzle layer 150.

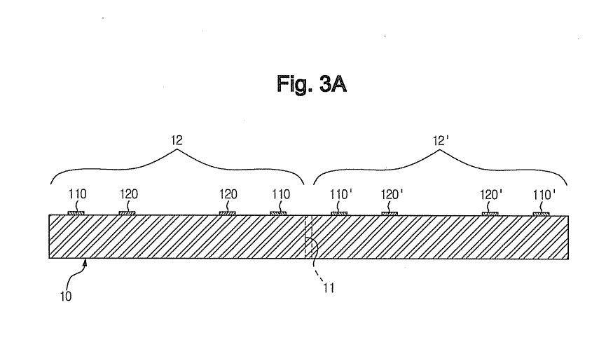

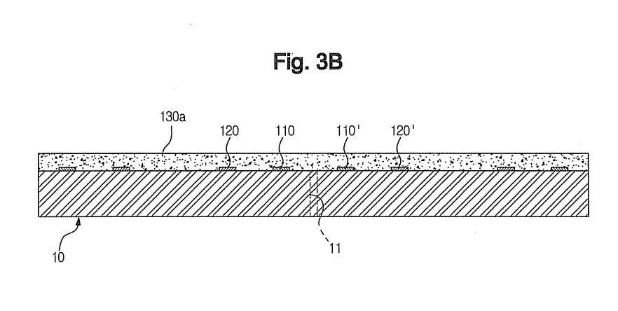

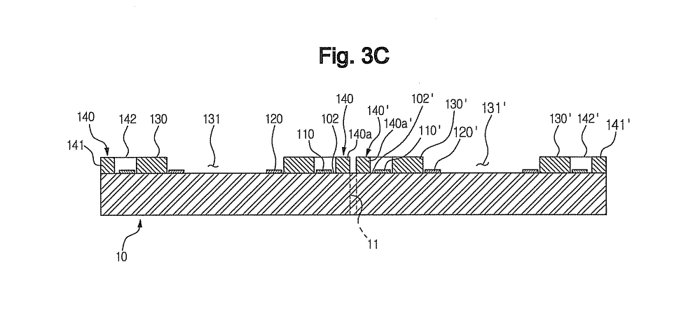

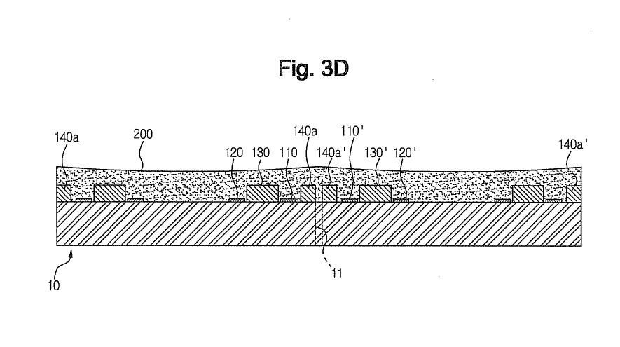

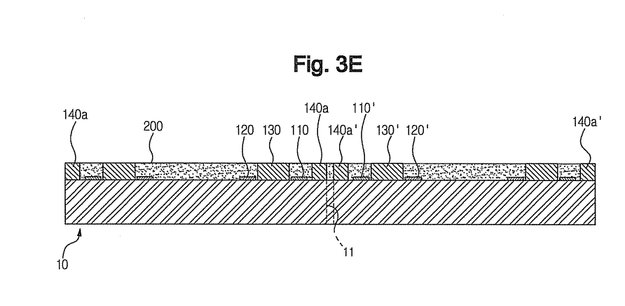

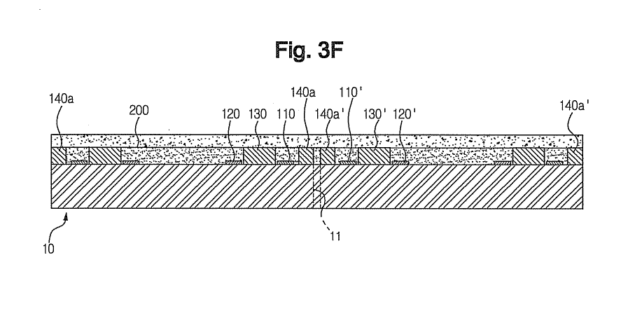

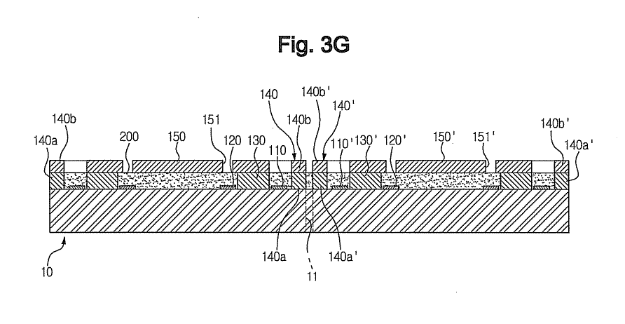

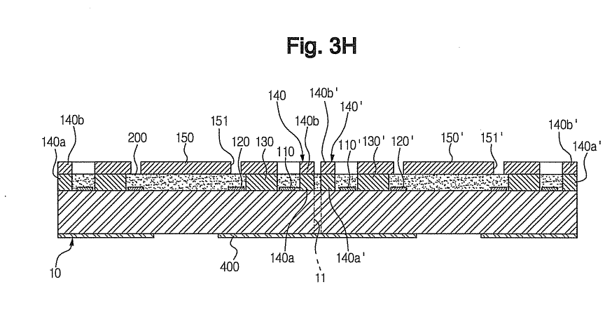

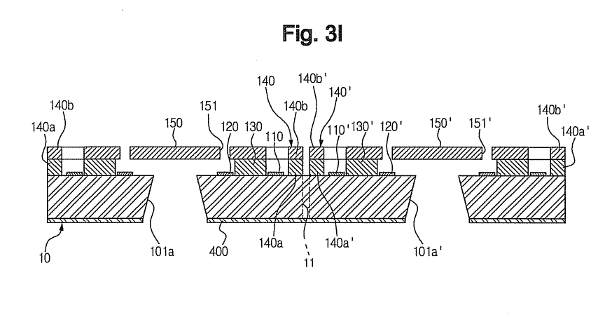

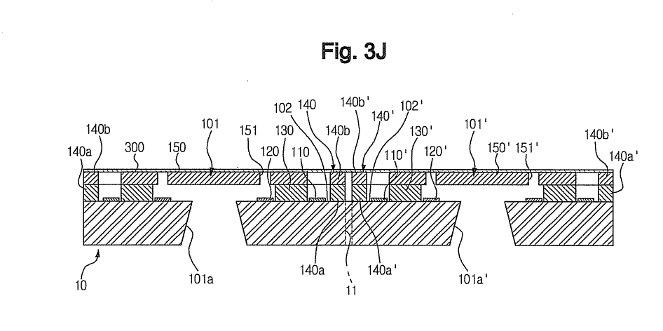

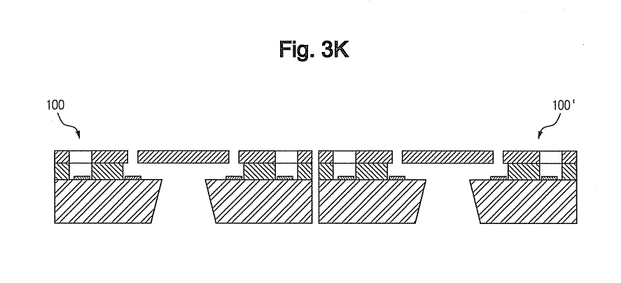

FIGS. 3A-3K illustrate a method of manufacturing the ink-jet print head 100, in accordance with aspects of the present invention. For convenience in explanation, only two adjacent ink-jet print heads 100 and 100′ on the wafer 10 are depicted in FIGS. 3A-3K.

As shown in FIGS. 3A to 3K, the ink ejection parts 101 and 101′ are respectively formed at head chip regions 12 and 12′ (refer to FIG. 3A), which are divided by the cutting region 11 on the wafer 10. The head chip regions 12 and 12′ include pad regions 102 and 102′, to which the connecting pads 110 and 110′ are mounted. The head chip regions 12 and 12′ are separated by cutting the wafer (substrate) 10. Then, each of the head chip regions 12 and 12′ becomes an individual ink-jet print head 100. A detailed explanation of the method for manufacturing the ink-jet print head, according to aspects of the present invention will now be made.

As shown in FIG. 3A, the heaters 120 and 120′ and the connecting pads 110 and 110′ are mounted to the head chip regions 12 and 12′. The heaters 120 and 120′ may be prepared by depositing a resistance heating material, such as, tantalum-nitride or a tantalum-aluminum alloy, using sputtering or chemical vapor deposition, and patterning the same. Also, the connecting pads 110 and 110′ may be prepared by depositing a metal material having sufficient conductivity, such as aluminum, using sputtering, and patterning the same.

As shown in FIGS. 3B and 3C, the flow channel layers 130 and 130′ are formed on the wafer 10, on which the heaters 120 and 120′ and the connecting pads 110 and 110′ are provided, by a photolithography process. In detail, a negative photoresist layer 130a (refer to FIG. 3B) is coated on the wafer 10, using a spin coating method. The photoresist layer 130a is exposed by using a photomask, on which a pattern corresponding to the inflow chamber 131 is formed. The photoresist layer 130a is developed to remove the non-exposed sections. Through the above processes, as shown in FIG. 3C, the flow channel layers 130 and 130′, defining the ink flow channels 131 and 131′, are formed.

In the process of forming the flow channel layers 130 and 130′, the first layers 140a and 140a′ of the partition walls 140 and 140′ are also formed. The photoresist layer 130a is exposed with a pattern corresponding to the partition walls 140 and 140′. The partition walls 140 and 140′ have the extending portions 141 and 141′ and the bent portions 142 and 142′, and surround the pad regions 102 and 102′, so that the exposed portions of the photoresist layer 130a remain in the development process, to form the first layers 140a and 140a′ of the partition walls 140 and 140′.

As shown in FIG. 3D, a sacrificial layer 200 is formed to cover the wafer 10, the flow channel layers 130 and 130′, and the first layers 140a and 140a′ of the partition walls 140 and 140′. The sacrificial layer 200 may be formed by coating a positive photoresist, by a spin coating method.

As shown in FIG. 3E, the upper surfaces of the sacrificial layer 200, the flow channel layers 130 and 130′, and the first layers 140a and 140a′ of the partition walls 140 and 140′ are flattened, through a chemical mechanical polish (CMP) process, so that the flow channel layers 130 and 130′, the first layers 140a and 140a′ of the partition walls 140 and 140′, and the sacrificial layer 200 have the same heights. This insures that the nozzle layers 150 and 150′ are formed on the flow channel layers 130 and 130′, and closely contact the first layers 140a and 140a′ of the partition walls 140 and 140′. Accordingly, the durability of the print head 100 is improved.

As shown in FIGS. 3F and 3G, the nozzle layers 150 and 150′ are formed on the flattened sacrificial layer 200 and the flow channel layers 130 and 130′. Similarly to the flow channel layers 130 and 130′, the nozzle layers 150 and 150′ are formed through a photolithography process. In detail, a photoresist 150b is coated on the sacrificial layer 200 and the flow channel layers 130 and 130′. The photoresist layer 150b is exposed through a photomask having a nozzle pattern. The photoresist layer 150b is developed to remove the non-exposed sections. Through the above processes, as shown in FIG. 3G, the nozzle layers 150 and 150′, having the nozzles 151 and 151′, are formed.

In the process of forming the nozzle layers 150 and 150′, the second layers 140b and 140b′ of the partition walls 140 and 140′ are also formed. The photoresist layer 150b is exposed with a shape corresponding to the partition walls 140 and 140′, so that the exposed portions of the photoresist layer 150b remain in the development process, to form the second layers 140b and 140b′ of the partition walls 140 and 140′. The partition walls 140 and 140′ generally have the same height as the nozzle layers 150 and 150′. This configuration allows for securely attaching a protective member 300 to the partition walls 140 and 140′, before cutting the wafer 10. Accordingly, the protective member 300 is prevented from being separated from the partition walls 140 and 140′ when cutting the wafer 10 (refer to FIG. 3J).

As shown in FIG. 3H, an etch mask 400 is provided on the bottom surface of the wafer 10, to form the ink supply ports 101a and 101a′ (refer to FIG. 3I). The etch mask 400 may be prepared by coating a positive or negative photoresist on the bottom surface of the wafer 10, and patterning the same.

As shown in FIG. 3I, the ink supply ports 101a and 101a′ are formed such that the portions of the wafer 10, exposed through the etch mask 400, are etched from the bottom surface of the wafer 10 to the top surface of the wafer 10. The etch mask 400 and the sacrificial layer 200 are removed. The wafer 10 may be etched through a dry etching process, using plasma. Alternatively, the wafer 10 may be etched through a wet etching process, using tetramethyl ammonium hydroxide (TMAH) or potassium hydroxide (KOH), as an etchant.

As shown in FIG. 3J, the protective member 300 is attached to and covers the ink ejection parts 101 and 101′, the pad regions 102 and 102′, and the partition walls 140 and 140′. The protective member 300 may be configured as an adhesive tape, which has a bonding agent coated on one surface thereof. The protective member 300 prevents the particles generated when cutting the wafer 10 from scattering on the ink ejection parts 101 and 101′ and/or the pad regions 102 and 102′.

Finally, the wafer 10 is cut along the cutting region 11, by using a cutting instrument, to separate the head chip regions 12 and 12′ (refer to FIG. 3A) from each other. The protective member 300 is then removed. The cutting instrument can be, for example, a wheel saw or the like. Through this process, the manufacturing of the individual ink-jet print heads 100 and 100′ is completed, as shown in FIG. 3K.

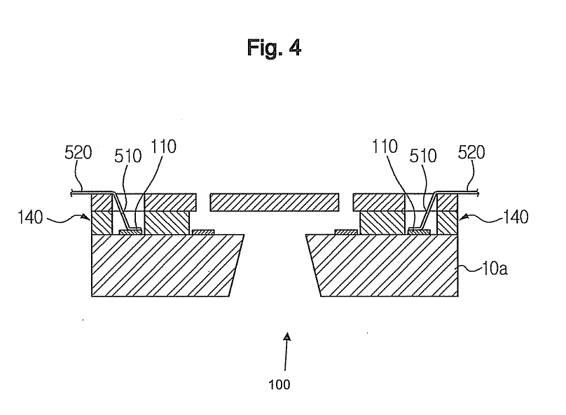

FIG. 4 is a sectional view illustrating lead wires of a flexible printed circuit (FPC) that are connected to the ink-jet print head 100, in accordance with aspects of the present invention. As shown in FIG. 4, the connecting pads 110 of the ink-jet print head 100 are connected to FPC cables 520, which have a plurality of lead wires 510 corresponding to the connecting pads 110. The partition walls 140 prevent the lead wires 510 from contacting the substrate 10a.

As is apparent from the above description, an ink-jet print head, according to aspects of the present invention, is capable of preventing the components of the print head from being contaminated by scattered particles, when cutting a wafer including a plurality of the ink-jet print heads. Accordingly, print quality is maintained and/or print malfunctions, due to the contamination of the print head, are prevented. Since lead wires of an FPC are prevented from contacting the substrate, an electrical short is prevented.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An ink-jet print head comprising:
a substrate having pad regions;
an ink ejection part disposed on the substrate adjacent to the pad regions, to eject ink;
connecting pads disposed in the pad regions, to apply an electric signal to the ink ejection part; and
partition walls disposed along edges of the pad regions, to block particles generated when the edges of the substrate are cut, from entering the pad regions,
wherein each of the partition walls includes an extending portion that extends along one side of the pad regions, and bent portions that extend from the extending portion.

2. The ink-jet print head according to claim 1, wherein in each of the partition walls the bent portions are disposed substantially orthogonal to the extending portion.

3. The ink-jet print head according to claim 1, wherein each of the partition walls is formed as a unitary body.

4. The ink-jet print head according to claim 1, wherein the ink ejection part includes a flow channel layer defining an ink chamber to hold the ink, and the bent portions extend to contact the flow channel layer.

5. The ink-jet print head according to claim 1, wherein the ink ejection part includes a nozzle layer defining a nozzle through which the ink is ejected, and the bent portions extend to contact the nozzle layer.

6. The ink-jet print head according to claim 1, wherein the ink ejection part includes a flow channel layer defining an ink chamber to hold the ink, and each of the partition walls includes a first layer consisting of the same material as the flow channel layer.

7. The ink-jet print head according to claim 6, wherein the ink ejection part further includes a nozzle layer disposed on the flow channel layer, and each of the partition walls further comprises a second layer which disposed on the first layer, consisting of the same material as the nozzle layer.

8. The ink-jet print head according to claim 7, wherein each of the partition walls has substantially the same height relative to the substrate, as the nozzle layer.

9. An ink-jet print head comprising:
a substrate having pad regions;
an ink ejection part disposed on the substrate adjacent to the pad regions, comprising a flow channel layer and a nozzle layer disposed on the flow channel layer;
plurality of connecting pads disposed in the pad regions, to control the ink ejection part; and
partition walls disposed along three sides of the pad regions, adjacent to edges of the substrate.

10. The ink-print head according to 9, wherein the pad regions are surrounded by a combination of the flow channel layer, the nozzle layer, and the partition walls.

11. A method for manufacturing ink-jet print heads on a wafer, comprising:
forming the ink ejection part and the connecting pads on head chip regions of a wafer, which are separated from one another by cutting regions;
forming partition walls between the pad regions and the cutting regions, while forming the ink ejection part, to separate the pad regions from the cutting regions;
attaching a protective member to cover the ink ejection part, the pad regions, and the partition walls; and
cutting the wafer along the cutting regions, to separate the head chip regions from each other.

12. The method according to claim 11, wherein the forming of the partition walls comprises:
forming an extending portions that extend along one side of each of the pad regions; and
forming bent portions that extend from each of the extending portions.

13. The method according to claim 12, wherein in each of the partition walls, the bent portions are disposed substantially orthogonal to the extending portion.

14. The method according to claim 11, wherein the forming of the ink ejection part comprises forming a flow channel layer defining an ink chamber, and wherein each of the partition walls includes a first layer which is formed together with the flow channel layer.

15. The method according to claim 14, wherein the forming of the ink ejection part comprises forming a nozzle layer on the flow channel layer, and each of the partition walls further comprises a second layer which is formed together with the nozzle layer.

16. The method according to claim 15, wherein each of the partition walls has substantially the same height relative to the substrate, as the nozzle layer.
